(19) United States
(12) Patent Application Publication
(10) Pub. No.: US 2005/0243653 A1
(43) Pub. Date: Nov. 3, 2005

(54) Electronic device with secondary display projection

(76) Inventor: Ronald S. Lizzi, Bethany, CT (US)

Correspondence Address: Arthur G. Schaier;Carmody & Torrance LLP, 50 Leavenworth Street, P.O. Box 1110, Waterbury, CT, 06721-1110, US

(21) Appl. No.: 10/833,372

(22) Filed: Apr. 28, 2004

(51) Int. Cl. G04C 23/00; G04B 25/00; H04M 11/00

(52) U.S. Cl. 368/71

(57) ABSTRACT

An electronic device for conveying first information by the use of hands and having a secondary display for displaying secondary information, wherein the electronic device comprises an at least partially light transparent dial, the dial having a dial side and an actuation mechanism side; at least a first hand for conveying first information and rotateable about a stem that projects through the dial, wherein the at least first hand is positioned on the dial side of the dial; an actuation mechanism, operatively coupled to the first hand, for rotation thereof at least in one of a clockwise and counterclockwise direction; wherein the secondary display comprises a plurality of illuminable display segments positioned on the actuation mechanism side of the dial; and means for driving the plurality of illuminable display segments; wherein the plurality of illuminable display segments can be illuminated to display secondary information and wherein the plurality of illuminable display segments, upon illumination, are visible through the at least light transparent portion of the dial.

### BACKGROUND OF THF INVENTION

The present invention relates generally to timepieces with a date display, and in particular, to an electronic device, such as a timepiece, that can tell time or convey other information using hands (e.g. in an “analog” manner), while also being able to convey yet further information, such as the date by way of example, using an LED display.

The “digital” watch has been around for several decades. Those who were around at the “beginning” might readily recall the use of 7 segment displays to indicate the time and date. Actuation of a pusher, most often a side pusher, activated the LED segments of the LED digits of the LED display, which themselves were controlled by a microcontroller, thereby providing the time on the LED display. Also well-known in the prior art is the use of liquid crystal segmented displays (LCD) to display the date.

At least most of the known “analog” type watches that have date displays use date wheels, the mechanical technology therefor being well-known in the art. At least one watch style is known to provide an LCD layer above the dial, thereby using conventional hands to display the time while using the LCD to display the date. Also well known is the “combo” watch, such as that disclosed in U.S. Pat. No. 5,691,962. However, a perceived deficiency in such designs and in the combo watch in particular is that they are thought to be less than aesthetically pleasing.

Accordingly, it would be desirable to provide an electronic device, such as an analog timepiece, that utilizes an analog movement for telling time and providing other information, while using LED technology to provide date and/or still further information, which is perceived to also be more aesthetically pleasing than those constructions described above. This configuration, whereby an LED display or an LED backlight in combination with an LCD is used and placed behind the dial, is believed to be novel, unobvious and advantageous over the prior art.

### SUMMARY AND OBJECTS OF THE INVENTION

Accordingly, it is an objective of the present invention to provide an electronic device, such as a timepiece, with a desirable secondary display using LEDs.

Another objective of the present invention is to utilize the LED display to provide yet additional information that may be desirable to the user of the device.

Still another objective of the present invention is to use an LED backlight, in combination with an LCD display positioned behind the dial, to provide an aesthetically pleasing secondary display for the purposes set forth herein.

Still another object of the present invention to provide an analog timepiece with a secondary display that is inexpensive and easy to manufacture.

Still another object of the present invention is to provide an electronic device, such as a timepiece, in which size of the date or other information desirous of display on the secondary display can be increased, while maintaining visual aesthetic appeal to the user.

It is still a further objective of the present invention to provide a timepiece with a date display that need not be adjusted at least five (5) times a year.

It is still a further objective of the present invention to provide an electronic device that has the versatility that is further disclosed herein.

Still other objects and advantages of the invention will in part be obvious and will in part be apparent from the specification.

The invention accordingly comprises the features of construction, combination of elements, arrangement of parts and sequence of steps which will be exemplified in the construction, illustration and description hereinafter set forth, and the scope of the invention will be indicated in the claims.

Generally speaking, in accordance with the present invention, an electronic device for conveying first information by the use of hands and having a secondary display for displaying secondary information is provided. In a preferred embodiment, the electronic device comprises an at least partially light transparent dial, the dial having a dial side and an actuation mechanism side; at least an hour hand and a minute hand for conveying at least time of day information and rotateable about the same axis, wherein the hour hand and the minute hand are positioned on the dial side of the dial; an actuation mechanism, operatively coupled to the hour hand and the minute hand, for rotation thereof at least in one of a clockwise and counterclockwise direction; wherein the secondary display comprises an LED display comprising at least two LED digits each of which comprises a plurality of LED display segments, wherein the at least two LED digits are positioned on the actuation mechanism side of the dial; and means for driving the LED display; wherein the LED display segments can be illuminated to display secondary information and wherein the LED display segments, upon illumination, are visible through the at least light transparent portion of the dial. In a specific embodiment, the timepiece comprises switching means for actuation of the LED display segments; wherein the LED display segments are not visible through the at least partially light transparent dial when the LED display segments are not actuated. In other provided features, the timepiece may comprise means for sequentially illuminating selective LED display segments and sufficient illumination by the LED display to facilitate reading of the information conveyed by the hands. In a preferred embodiment, the secondary information is date information.

In another embodiment, an electronic device, which may or may not be a timepiece, is provided. In this embodiment, which conveys first information by the use of hands and has a secondary display for displaying secondary information, the electronic device comprises an at least partially light transparent dial, the dial having a dial side and an actuation mechanism side; at least a first hand for conveying first information and rotateable about a stem that projects through the dial, wherein the at least first hand is positioned on the dial side of the dial; an actuation mechanism, operatively coupled to the first hand, for rotation thereof at least in one of a clockwise and counterclockwise direction; wherein the secondary display comprises an LED display comprising at least two LED digits each of which comprises a plurality of LED display segments, wherein the at least two LED digits are positioned on the actuation mechanism side of the dial; and means for driving the LED display; and switching means for actuation of the LED display segments; wherein the LED display segments are not visible through the at least partially light transparent dial when the LED display segments are not actuated, and wherein the LED display segments are illuminable to display secondary information and wherein the LED display segments, upon illumination, are visible through the at least light transparent portion of the dial.

In yet another embodiment, an electronic device for conveying first information by the use of hands and having a secondary display for displaying secondary information, is provided. In this embodiment, the electronic device preferably comprises an at least partially light transparent dial, the dial having a dial side and an actuation mechanism side; at least a first hand for conveying first information and rotateable about a stem that projects through the dial, wherein the at least first hand is positioned on the dial side of the dial; an actuation mechanism, operatively coupled to the first hand, for rotation thereof at least in one of a clockwise and counterclockwise direction; wherein the secondary display comprises a plurality of illuminable display segments positioned on the actuation mechanism side of the dial; and means for driving the plurality of illuminable display segments; wherein the plurality of illuminable display segments can be illuminated to display secondary information and wherein the plurality of illuminable display segments, upon illumination, are visible through the at least light transparent portion of the dial. Similarly, a specific embodiment may comprise switching means for actuation of the illuminable display segments; wherein the illuminable display segments are not visible through the at least partially light transparent dial when the illuminable display segments are not actuated. In a specific embodiment, the plurality of illuminable display segments are LED display segments.

Lastly, in yet a further embodiment of the present invention, the electronic device may comprise an at least partially light transparent dial, the dial having a dial side and an actuation mechanism side; at least a first hand for conveying first information and rotateable about a stem that projects through the dial, wherein the at least first hand is positioned on the dial side of the dial; an actuation mechanism, operatively coupled to the first hand, for rotation thereof at least in one of a clockwise and counterclockwise direction; wherein the secondary display comprises an LCD positioned on the actuation mechanism side of the dial; a light source positioned on the actuation mechanism side of the dial, wherein the LCD is positioned intermediate the dial and the light source; means for selectively activating portions of an area of the LCD; and means for illuminating the light source; wherein, when the light source is illuminated, the light from the light source is visible through the clear portions of the LCD; whereby the secondary information being conveyed by the LCD is visible through the at least light transparent portion of the dial. In a particular embodiment, the light source is comprised of one or more LEDs. Likewise, switching means may be provided for actuation of the light source; wherein the LCD is not visible through the at least partially light transparent dial when the light source is not illuminated. In specific embodiments, the selective activation of the portions of the area of the LCD go from dark to clear, and the light from the light source is bounded by dark portions of the LCD. Alternatively, the selective activation of the portions of the area of the LCD go from clear to dark, and the light from the light source bounds the dark portions of the LCD. In this latter configuration, the light source provides illumination of the dial outside of the area immediately above the LCD display, to facilitate reading of the information conveyed by the hands.

In a specific embodiment, the electronic devices disclosed herein are timepieces.

### BRIEF DISCRIPTION OF THF DRAWINGS

For a fuller understanding of the invention, reference is had to the following description taken in connection with the accompanying figures, in which:

FIG. 1 is an exploded view of an electronic device constructed in accordance with the present invention, illustrating but one exemplary placement of the secondary display constructed in accordance with the present invention;

FIG. 2 is a perspective view of the electronic device of FIG. 1, illustrating a portion of the dial removed to illustrate how the secondary display can be provided without any interference with the mechanical assemblies provided in such a device;

FIG. 3 is a simplified plan view of an alternative position of the secondary display, illustrating the advantageous nature of the present invention;

FIG. 4 is a cross-sectional view, which for exemplary purposes, illustrates the LEDs positioned consistent with those in FIG. 3, but should be not so limiting since the mere movement of the LED digits, for example (and reduction in number from four (4) to two (2)) would represent a fully disclosed cross-sectional view of the electronic device constructed in accordance with the orientation of the LEDs as illustrated in FIGS. 1 and 2;

FIG. 5 is a cross-sectional view of an alternative embodiment of the present invention, illustrating a liquid crystal display (LCD) with an LED (but which should be deemed to generically discloses a plurality of LEDs, if desired) positioned behind the LCD, the purpose of which, as disclosed further below, is to provide a unique secondary display in which the energizing of the liquid crystals determines the pattern of light that is emitted therethrough;

FIG. 6 illustrates an exemplary number (e.g. “31”) being displayed using the construction set forth in FIG. 5, in which the LED(s) emits light through the LCD having a negative display (light segments on a dark background), and specifically, through the clear portion of the LCD where the “3” and the “1” patterns are formed, with the “3” and the “1” being seen in the color of the light being illuminated by the LED (e.g. red);

FIG. 7 is an exemplary timepiece with the display constructed as in FIG. 6;

FIG. 8 illustrates an exemplary number (e.g. “31”) being displayed using the construction set forth in FIG. 5, in which an LED(s) emits light through an LCD having a positive display (dark segments on a light background), where the display of the secondary information (e.g. “31”) is the color of the dial (or otherwise dark) and is surrounded by the color being illuminated by the LED light; and

FIG. 9 is an exemplary timepiece with the display constructed as in FIG. 8.

Also, while not all elements are labeled in each figure, all elements with the same reference number indicate similar or identical parts.

### DETAILD DESCRITPTION OF THF PREFFRRFD EMBODIMENTS

Reference will now be made to FIGS. 1-4, for a disclosure of an electronic device, generally indicated at 10, constructed in accordance with the present invention. In the preferred embodiment, electronic device 10 is a timepiece, and a wristwatch in particular, but this is by way of example and not limitation, as other devices, such as a heartrate monitor and/or compass are clearly contemplated herein. To be sure, all the devices that are disclosed in copending and coowned application Ser. No. 10/441,417, the disclosure of which is incorporated by reference as if fully set forth herein, are equally applicable to the present invention, and thus contemplated hereby.

Accordingly, in a broad sense, a first embodiment of the present invention is directed to an electronic device for conveying first information by the use of hands and having a secondary display for displaying secondary information, wherein the electronic device comprises an at least partially light transparent dial, the dial having a dial side and an actuation mechanism side; at least a first hand for conveying first information and rotateable about a stem that projects through the dial, wherein the at least first hand is positioned on the dial side of the dial; an actuation mechanism, operatively coupled to the first hand, for rotation thereof at least in one of a clockwise and counterclockwise direction; wherein the secondary display comprises a plurality of illuminable display segments positioned on the actuation mechanism side of the dial; and means for driving the plurality of illuminable display segments; wherein the plurality of illuminable display segments can be illuminated to display secondary information and wherein the plurality of illuminable display segments, upon illumination, are visible through the at least light transparent portion of the dial.

In a first specific embodiment, to which reference shall now be directed, the present invention is directed to an electronic device that has comprising the secondary display, an LED display comprising at least two LED digits each of which comprises a plurality of LED display segments, wherein the at least two LED digits are positioned on the actuation mechanism side of the dial; and means for driving the LED display; wherein the LED display segments can be illuminated to display secondary information and wherein the LED display segments, upon illumination, are visible through the at least light transparent portion of the dial.

In a particular embodiment, the actuation mechanism comprises a stepper motor.

Advantageously, where the hand is conveying other than time of day information, the secondary information can therefore be, but is not limited to, the time of day. In a more particular embodiment, which will hereinafter be described first, the electronic device is a timepiece.

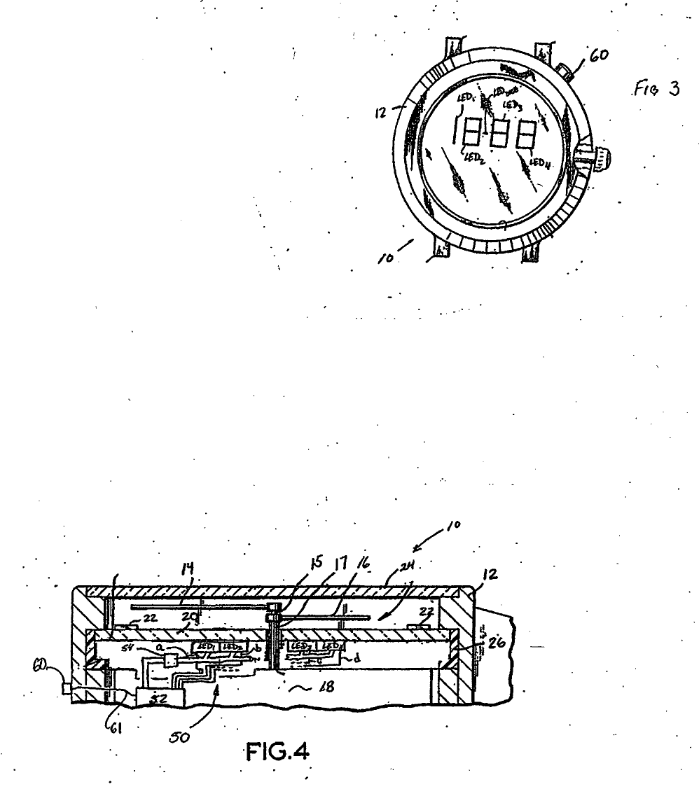

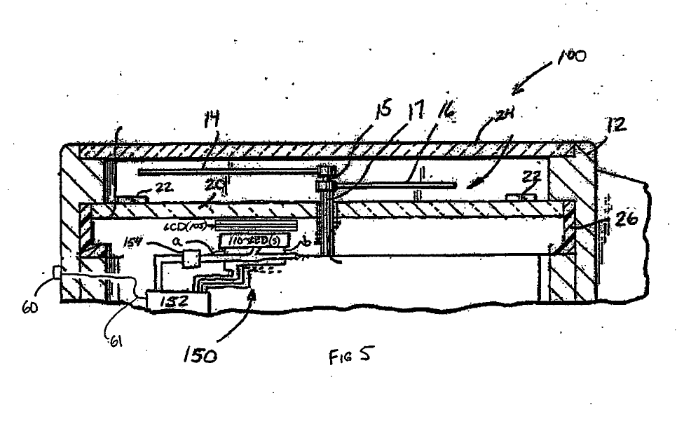

Therefore turning to the particulars whereby electronic device 10 is a timepiece, FIGS. 1-4 illustrate electronic device 10 comprising a conventional case 12. For the “analog” portion of the present invention and display of “first” information, a minute hand 14 and an hour hand 16 are mounted on rotateable stems (respectively 15, 17 (FIG. 4)). As indicated above, in the event electronic device 10 is not a conventional timepiece, but rather some other device, such as a compass, heartrate monitor by way of example and not limitation, reference should be had to the aforementioned application Ser. No. 10/441,417. In this way, the claimed “first hand” could find correspondence for any of the hands disclosed therein, such as one of the “dash” hands or the fourth hand, as well as the minute, second or hour hand when device 10 is a timepiece. As illustrated in FIG. 1 in detail, and more generically by reference numeral 18 in FIG. 4, hands 14 and 16 are driven by a conventional movement, such as an actuation mechanism, which in the preferred embodiment comprises a stepper motor that itself comprises a rotor, the stepper motor being operatively coupled to the hour and minute hand, for stepping in at least one of a clockwise and counterclockwise direction in predefined increments. As illustrated in FIG. 1 but not material to the present invention, as well as being fully understood by one ordinarily skilled in the art, minute and hour hands 14, 16 have a gear train operatively coupled thereto, wherein the rotational activity generated by the rotor of the stepper motor is conveyed to the gear train which in turn causes the rotation of the hour and minute hands. Again, although the details are not material thereto, the reader may refer to the aforementioned '417 application for details of additional and differently positioned hands and actuation mechanisms. Furthermore, reference may be had to additional copending and coowned application Ser. Nos. 10/730,200; 10/349,339; 10/716,011; and 10/342,512, the disclosures of which are incorporated herein by reference as if fully set forth herein, for a more detailed description of a conventional analog movement for hands 14, 16. Moreover, the present invention is readily adaptable and the disclosure as well as the claims cover and embodiments in which a second hand is employed.

Below hands 14, 16 is a dial 20 having time indicating indicia thereon, such as the hour and minute markers 22 and provided thereon by a variety of methods, such as printing, painting and/or silk-screening, using conventional techniques well known in the art. FIGS. 1 and 4 most clearly illustrate that dial 20 is a thin flat member cut in the shape of a watch dial and having a central hole therein for accommodating the watch stem. As will become relevant in a moment, dial 20 is at least partially light transparent (i.e. allowing light to pass therethrough). Most preferably, a coating of a reflective material may be provided to reflect light striking dial 20 from the dial side (e.g. on the side where hands 14, 16 are positioned). In this way, when the LED display is not being illuminated, the LED display is not easily viewed when looking at dial 20. Such a construction will improve the aesthetics of the dial face.

Referring now generally to FIG. 4, but appreciating that this FIG. 4 construction, in a general sense, also illustrates the construction of FIG. 1 (with the minor distinctions being indicated below), it can be seen that hands 14, 16 are mounted upon coaxial rotating stems which are centrally located and connected to be rotated or periodically “stepped” by actuation mechanism 18, which again, preferably comprises a stepping motor actuated by an integrated circuit with a quartz time base and driving a gear train ultimately connected to stems 15, 17 in a manner well known in the art, and more fully set forth in the aforementioned applications incorporated herein by reference. Case 12 or bezel includes a transparent crystal 24 through which to observe hands 14, 16 and their position in relation to indicia 22 on dial 20.

Dial 20 is preferably mounted in case 12 by means of an insulating gasket 26, which supports dial 20 about its periphery, and assists in guarding against cracking or breakage of dial 20 as well as electrically insulation thereof. Dial 20 is preferably made of glass or flexible plastic film such as MYLAR®.

Electronic device 10 also comprises an LED display, generally indicated at 50.

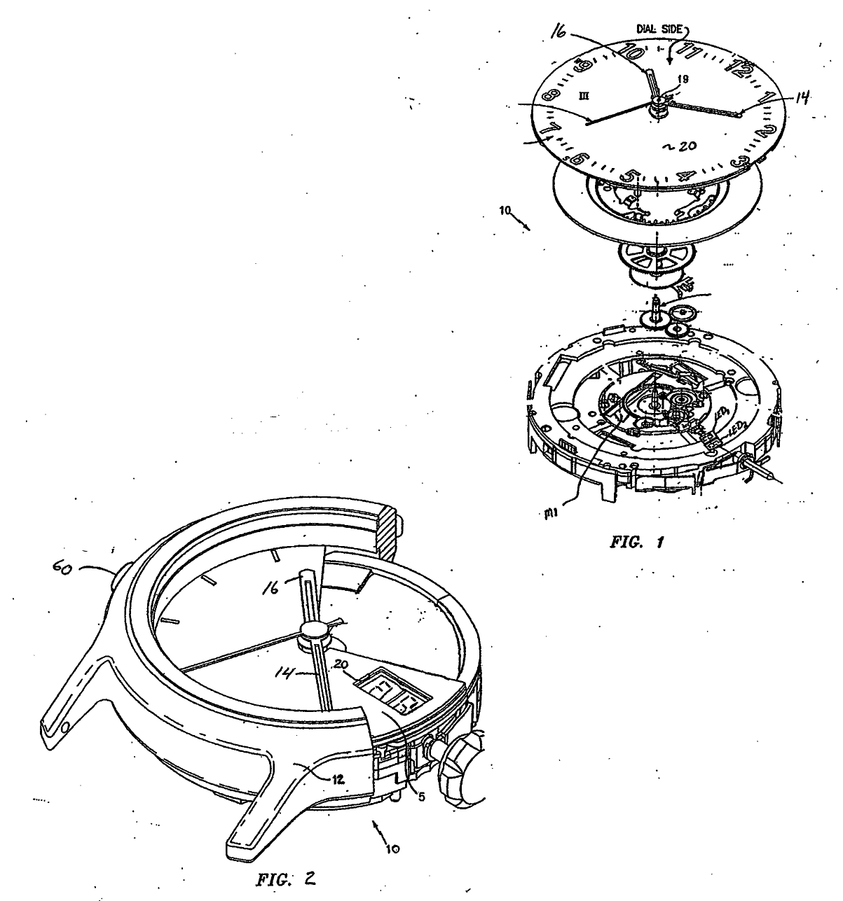

LED display 50 preferably comprises a plurality of LED digits, each LED digit comprising a plurality (e.g. 7) of LED segments, positioned on the actuation mechanism side of the dial. For exemplary purposes, FIGS. 1 and 2 each illustrate the use of two LED digits (LED₁, LED₂), while FIGS. 3 and 4 illustrate the use of four LED digits (LED₁, LED₂, LED₃, LED₄). An optional LED, referenced by indication “LED_{DASH}” may be provided in the embodiment of FIGS. 3 and 4 to separate the month (e.g. “-”) or the hour from the minute (e.g. “:”) in the event that the secondary display is displaying time of day information. However, to be clear, even more LED digits are within the scope of the present invention. For example, additional LED digits could be incorporated for displaying a day indicator (e.g. MON, TUE . . . ) and/or a year indicator, if the segments are arranged and aligned accordingly.

FIG. 4 also generally discloses the circuitry for driving LED display 50, which comprises a controller 52 and a set of LED segment drivers, shown in the block diagram as reference numeral 54. As should be well appreciated, controller 52 may be separate from and/or part of the controller used in connection with the controller to control hands 14, 16. If separate therefrom, then the two controllers will be operatively coupled to each other in order to communicate information, such as time and date information, such that movement of hands 14, 16 through a 12 o'clock midnight position (either from a clockwise or counterclockwise direction) is correctly reflected in the displayed secondary information displayed by LED display 50. Similar, the controller may be part of the single controller controlling the electronic device, such as controller 100 in the aforementioned '417 application.

Moreover, by “secondary” it is merely intended to indicate the advantageous nature of the present invention of providing information in addition to that which is provided by hands 14, 16 (or any other hand). In no way is “secondary” intended to mean “inferior” or “of a lesser importance,” but merely as terminology to differentiate it from, for example, the time of day if that is what the display hands are indicating. For example and not limitation, the “secondary” information may be date information (e.g. 22, 6-22, or 11-08) or an alternative timezone, for example. Likewise, if electronic device is a heartrate monitor for example, the secondary display and hence “secondary” information may in fact be the time of day.

The circuitry which includes controller 52 and/or drivers 54 is well known in the art and not material to the present invention. By way of example, Dallas Semiconductors makes available a plurality of conventional circuitries for providing LED display multiplexing. As a specific example, the description set forth at <www.maxim-ic.com/appnotes.cfm/appnote_number/1880>, a copy of which is attached hereto and incorporated by reference as if fully set forth herein, provides a suitable configuration for providing a reduced driver pin count by using pins alternatively as cathode and anode drivers, which may differ from standard LED multiplex connections, which use separate driver pins for anodes and cathodes. Again, however, it is believed that the block diagram illustrated in FIG. 4, in combination with well-known LED display techniques, in further combination with the descriptions of conventional circuits widely available such as that mentioned above, more than adequately enables the contemplated display of such “secondary” information.

Furthermore, one skilled in the art would know how to program such a controller 52, or more generic controller, such as controller 100 as disclosed in the aforementioned '417 application, so that controlling, maintaining and/or setting accurate date and/or time information for LED display need not be further disclosed.

A pusher, such as pusher 60 (shown in various positions in FIGS. 2 and 3 for exemplary purposes), is preferably operatively coupled to controller 52 (or the more generic controller 100) via a switch contact generically shown by connector 61 inside the case of the watch to activate LED display 50 in a known manner. In this way, LED display 50, and in particular, the LED digits and corresponding LED segments can be appropriately illuminated to display the secondary information and wherein the LED display, upon illumination, is visible at least through the light transparent portion of dial 20. Conventional features, such as controlling the display duration and/or brightness, may also be included, as described in various prior art patents, such as U.S. Pat. Nos. 4,207,734 and 3,765,163 the disclosures of which are incorporated by reference as if fully set forth herein. In this way, if desired, the user may adjust the brightness level of LED display 50 and/or select the particular length of time that she desires that LED display 50 be flashed on.

Additionally, the present invention provides for unique display sequencing. For example, as disclosed above, additional LED digits for displaying the year and/or a day (e.g. MON., TUE . . . ) may be included. Either way, whether there are for example, four LED digits (e.g. to display June 22→“06-22”) or more, sequential actuation of pusher 60 could sequentially begin with only illuminating the “22” (i.e. the left-most LED digits). A subsequent actuation of pusher 60 (e.g. while the “22” is still illuminated) would additionally illuminate the “06”. Still further actuation could provide for the illumination of the “day” and/or the year. Such methodology for programming controller 52 or 100 is well with the scope of the skilled artisan. Likewise, multiple pushers could be used for the foregoing. Even further, the secondary information could be displayed after a timeout (e.g. the user pushes a pusher a single time, for example, and the electronic device (e.g. timepiece) displays the month for a few seconds and then the date for a few seconds, or visa versa, all such clever display routines being within the purview of the skilled artisan.

The sequencing doesn't require additional button presses. It should also be understood that pusher 60 may also be incorporated into the crown itself, such that compression of the crown provides for the foregoing secondary display illumination. All such “switching means” for such secondary display illumination, including a switching means being incorporated into a rotating bezel (not shown) is contemplated herein.

Reference is now be made to FIGS. 5-9 for a disclosure of an electronic device, generally indicated at 100, constructed in accordance with an alternative embodiment of the present invention. So as not to repeat the entire disclosure set forth above, common reference numerals should be deemed to indicate like parts. Distinctions between the two embodiments shall now be set forth.

In this alternative embodiment, the electronic device likewise conveys first information by the use of hands and has a secondary display for displaying secondary information. For this reason, the electronic device likewise comprises an at least partially light transparent dial, the dial having a dial side and an actuation mechanism side; at least a first hand for conveying first information and rotateable about a stem that projects through the dial, wherein the at least first hand is positioned on the dial side of the dial; and an actuation mechanism, operatively coupled to the first hand, for rotation thereof at least in one of a clockwise and counterclockwise direction. Here however, the secondary display comprises an LCD positioned on the actuation mechanism side of the dial; and one or more LEDs positioned on the actuation mechanism side of the dial, wherein the LCD is positioned intermediate the dial and the one or more LEDs; means for selectively activating portions of an area of the LCD; and means for illuminating the one or more LEDs; wherein, when the one or more LEDs are illuminated, the light from the illuminated LEDs is visible through the activated portions of the LCD; whereby the secondary information is visible through the at least light transparent portion of the dial. Particulars, shall now be set forth.

Specifically, in this alternative embodiment, an LCD, generally indicated at 105, is positioned intermediate dial 20 and one or more LEDs, generally indicated at 110. The number of LEDs is within the purview of the designer, and a criterion that may be used to determine the desired number of LEDs is the desired illumination intensity or size of field.

In this configuration, a unique secondary display in which the energizing of the liquid crystals determines the pattern of light that is emitted therethrough. Controlling the patterns to be created using an LCD is very well known in the art, and therefore, details thereof have been omitted herein for purposes of brevity.

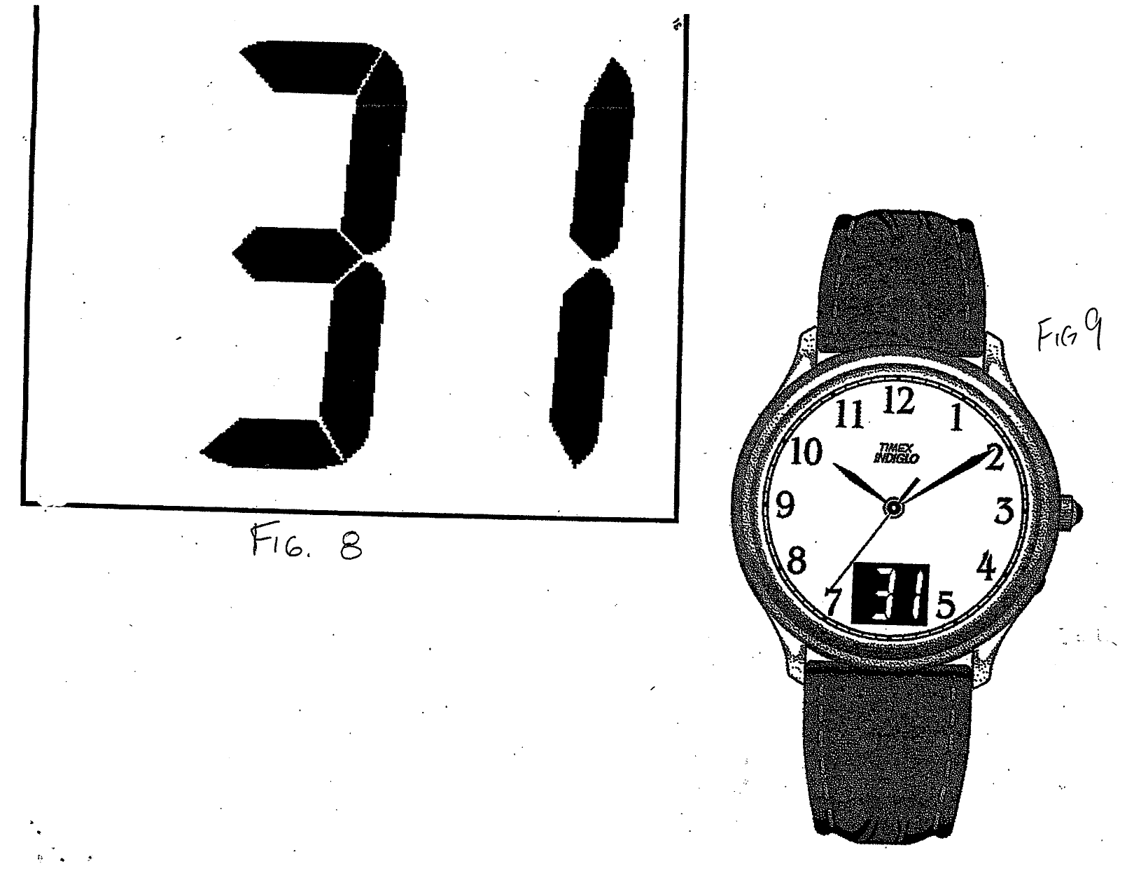

However, for purposes of disclosing the present invention, a preferred LCD may be a liquid crystal display used in timepieces utilizing conventional twisted-nematic (TN) displays. As is well-known in the art, when no voltage is placed across an area of the LCD, the area may appear dark (due to the inability of light to escape through the pair of polarizers), and when a threshold potential is applied between the counter-electrode and one of the selected area electrodes, the liquid crystal material located in the selected area will tend to orient themselves perpendicular to the polarized alignment, which causes the activated area to become clear. The light from the illuminated one or more LEDs 110 will shine through the activated area. The light from the illuminated one or more LEDs 110 is either visible or not, depending on the excitation (or not) of the liquid crystal material. As would be clear to create any digits or letters, each LCD segment may be deemed to be an activatable area. Likewise, to create the secondary information as illustrated in FIGS. 8 and 9, the outside region of the LCD would be the illuminable area.

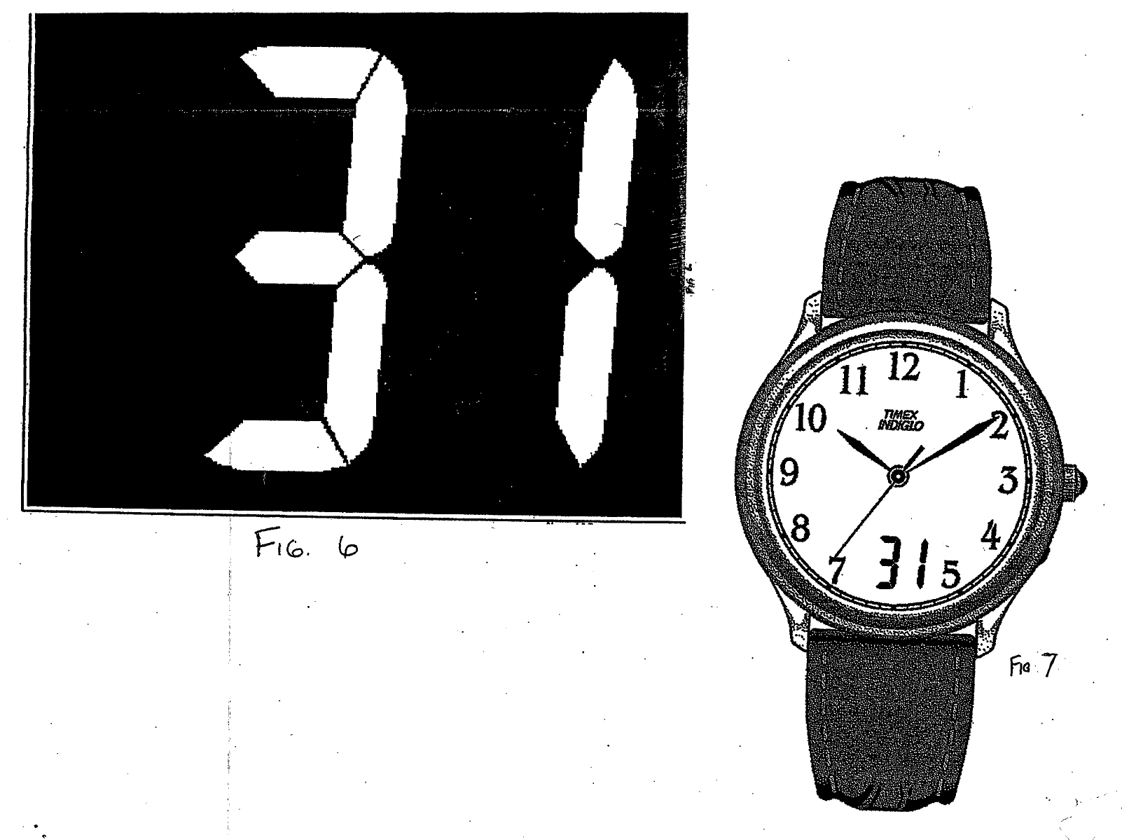

For example, FIG. 6 illustrates an exemplary number (e.g. “31”) being displayed using the construction set forth in FIG. 5, in which the one or more LEDs 110 emit light through an LCD 105 having a negative display (light segments on a dark background), and specifically, through the clear portion of the LCD where the “3” and the “1” patterns are formed, with the “3” and the “1” being seen in the color of the light being illuminated by the one or more LEDs 110 (e.g. red). FIG. 7 is an exemplary timepiece with the display of FIG. 6.

Alternatively, FIG. 8 illustrates an exemplary number (e.g. “31”) being displayed using the construction set forth in FIG. 5, in which the one or more LEDs 110 emit light through LCD 105 having a positive display (dark segments on a light background), where the display of the secondary information (e.g. “31”) is the color of dial 20 (or otherwise dark) and is surrounded by the color being illuminated by the light emanating from the one or more LEDs 110. Similarly, FIG. 9 is an exemplary timepiece with the display of FIG. 8.

In a similar manner, when the user desires to see the date or other secondary displayable information, the user would actuate a switch (e.g. pusher 60) or one of the other disclosed “switch means,” such as “pushing in” of the crown or rotating of the bezel, just to name a few. Likewise, sequential display of information, such as the day and/or year (or other displayable information) is likewise achievable by known methodology.

To that end, the non-trivial distinctions between FIG. 5 and FIG. 4 are as follows. That is, FIG. 5 can be seen to illustrate a controller 152 and a set of LED drivers, shown in the block diagram as reference numeral 154. In a similar manner, controller 152 may be separate from and/or part of the controller used in connection with the controller to control hands 14, 16. In this way, controller is in all ways similar to controller 52. Thus, the distinction of controller 152 is its further inclusion of software and/or hardware to additionally control LCD 105 (again, the actual control of an LCD display is very well known in the art) along with the control of the one or more LEDs 110. Similarly, controller 152 may be part of single controller controlling the electronic device, such as controller 100 in the aforementioned '417 application. In all other respects, the features, functions, abilities, purposes and construction of the embodiment of FIG. 4 and that of FIG. 5 are and should be deemed to be equivalent, if not identical, in the broadest sense. To be sure, one skilled in the art would know how to program and design controller 152, or a more generic controller, such as controller 100, so that controlling, maintaining and/or setting accurate date and/or time information for the combination LCD and LED backlighting need not be further described.

It can thus be seen that the present invention provides numerous advantages not found in the prior art. For example, the present invention provides an electronic device, such as a timepiece, with a desirable secondary display using LEDs. Further, the present invention utilizes the LED display to provide yet additional information that may be desirable to the user of the device. Additionally, the present invention provides a unique combination and aesthetically pleasing display using an LED backlight, in combination with an LCD display positioned behind the dial. Still further, the present invention provides an analog electronic device with a secondary display that is inexpensive and easy to manufacture. Still further, the present invention provides an electronic device, such as a timepiece, in which size of the date or other information desirous of display on the secondary display can be increased, while maintaining visual aesthetic appeal to the user.

While the invention has been particularly shown and described with respect to preferred embodiments thereof, it will be understood by those skilled in the art that changes in form and details may be made therein without departing from the scope and spirit of the invention.

To be sure for example, in the preferred embodiment, electronic timepiece 10 is a wristwatch, but other types of electronic devices, with and without sensors, such as a pocketwatch as but one example, are also contemplated herein. Furthermore, pushbutton sequencing, such as using a mode button, may permit the LED display to display more than merely only a date or alternative timezone information, but rather both. Also, electronic device 10 may comprise additional pushers to set the date, time of day and/or alternative timezone information. Such technology is well-known, and reference to timepieces that have both hands and an LCD (i.e. a “combo”) may be had for such software and programming features. Likewise, use of the crown may also be used for setting the LED display in a manner similar to the crown-set technology employed by Timex Corporation, whereby the displayed information, in this case the date or an alternative timezone, for examples, can be set using the crown. In this embodiment, axial positioning of the crown and the use of electrical contacts can be used to set/change the date and/or set/change the secondary information in a consistent manner. Likewise, the LEDs may be such that illumination thereof illuminates the entire dial for ease of reading the information conveyed by the hands, such as in the dark.

Lastly, other light emitting technology can be used, including what is known in the art as OLED, as well as electroluminescence technology, if patterned appropriately.

1. A timepiece for conveying first information in an analog manner and having a secondary display for displaying secondary information, wherein the timepiece comprises:
an at least partially light transparent dial, the dial having a dial side and an actuation mechanism side;
at least an hour hand and a minute hand for conveying at least time of day information and rotateable about the same axis, wherein the hour hand and the minute hand are positioned on the dial side of the dial;
an actuation mechanism, operatively coupled to the hour hand and the minute hand, for rotation thereof at least in one of a clockwise and counterclockwise direction;
wherein the secondary display comprises:
an LED display comprising at least two LED digits each of which comprises a plurality of LED display segments, wherein the at least two LED digits are positioned on the actuation mechanism side of the dial; and
means for driving the LED display;
wherein the LED display segments can be illuminated to display secondary information and wherein the LED display segments, upon illumination, are visible through the at least light transparent portion of the dial.

2. The timepiece as claimed in claim 1, including switching means for actuation of the LED display segments; wherein the LED display segments are not visible through the at least partially light transparent dial when the LED display segments are not actuated.

3. The timepiece as claimed in claim 2, including means for sequentially illuminating selective LED display segments.

4. The timepiece as claimed in claim 1, wherein the LED display provides illumination of the dial outside of the area immediately above the LED display, to facilitate reading of the information conveyed by the hands.

5. The timepiece as claimed in claim 1, wherein the secondary information is date information.

6. The timepiece as claimed in claim 1, wherein the means for driving the LED display comprises at least a controller and LED segment drivers.

7. An electronic device for conveying first information by the use of hands and having a secondary display for displaying secondary information, wherein the electronic device comprises:
an at least partially light transparent dial, the dial having a dial side and an actuation mechanism side;
at least a first hand for conveying first information and rotateable about a stem that projects through the dial, wherein the at least first hand is positioned on the dial side of the dial;
an actuation mechanism, operatively coupled to the first hand, for rotation thereof at least in one of a clockwise and counterclockwise direction;
wherein the secondary display comprises:
an LED display comprising at least two LED digits each of which comprises a plurality of LED display segments, wherein the at least two LED digits are positioned on the actuation mechanism side of the dial; and
means for driving the LED display;
and switching means for actuation of the LED display segments;
wherein the LED display segments are not visible through the at least partially light transparent dial when the LED display segments are not actuated, and wherein the LED display segments are illuminable to display secondary information and wherein the LED display segments, upon illumination, are visible through the at least light transparent portion of the dial.

8. The timepiece as claimed in claim 7, including means for sequentially illuminating selective LED display segments.

9. The timepiece as claimed in claim 7, wherein the LED display provides illumination of the dial outside of the area immediately above the LED display, to facilitate reading of the information conveyed by the hands.

10. The electronic device as claimed in claim 7, wherein the secondary information is date information.

11. The electronic device as claimed in claim 7, wherein the secondary information is the time of day.

12. The electronic device as claimed in claim 7, wherein the first hand is one of a minute or second hand.

13. The electronic device as claimed in claim 7, wherein the first hand is one for conveying heartrate information.

14. The electronic device as claimed in claim 7, comprising:
a second hand rotateable about a stem that projects through the dial, wherein the second hand is positioned on the dial side of the dial;
an actuation mechanism, operatively coupled to the second hand, for rotation thereof at least in one of a clockwise and counterclockwise direction;
wherein the second hand also conveys information to a user.

15. An electronic device for conveying first information by the use of hands and having a secondary display for displaying secondary information, wherein the electronic device comprises:
an at least partially light transparent dial, the dial having a dial side and an actuation mechanism side;
at least a first hand for conveying first information and rotateable about a stem that projects through the dial, wherein the at least first hand is positioned on the dial side of the dial;
an actuation mechanism, operatively coupled to the first hand, for rotation thereof at least in one of a clockwise and counterclockwise direction;
wherein the secondary display comprises:
a plurality of illuminable display segments positioned on the actuation mechanism side of the dial; and
means for driving the plurality of illuminable display segments;
wherein the plurality of illuminable display segments can be illuminated to display secondary information and wherein the plurality of illuminable display segments, upon illumination, are visible through the at least light transparent portion of the dial.

16. The timepiece as claimed in claim 15, including switching means for actuation of the illuminable display segments; wherein the illuminable display segments are not visible through the at least partially light transparent dial when the illuminable display segments are not actuated.

17. The timepiece as claimed in claim 16, including means for sequentially illuminating selective LED display segments .

18. The timepiece as claimed in claim 15, wherein the illuminable display provides illumination of the dial outside of the area immediately above the illuminable display, to facilitate reading of the information conveyed by the hands.

19. The electronic device as claimed in claim 15, wherein the electronic device is a timepiece.

20. The electronic device as claimed in claim 15, wherein the plurality of illuminable display segments are LED display segments and form an LED display comprising at least two LED digits each of which comprises at least a portion of the plurality of LED display segments.

21. An electronic device for conveying first information by the use of hands and having a secondary display for displaying secondary information, wherein the electronic device comprises:
an at least partially light transparent dial, the dial having a dial side and an actuation mechanism side;
at least a first hand for conveying first information and rotateable about a stem that projects through the dial, wherein the at least first hand is positioned on the dial side of the dial;
an actuation mechanism, operatively coupled to the first hand, for rotation thereof at least in one of a clockwise and counterclockwise direction;
wherein the secondary display comprises:
an LCD positioned on the actuation mechanism side of the dial;
a light source positioned on the actuation mechanism side of the dial,
wherein the LCD is positioned intermediate the dial and the light source;
means for selectively activating portions of an area of the LCD; and
means for illuminating the light source;
wherein, when the light source is illuminated, the light from the light source is visible through the clear portions of the LCD;
whereby the secondary information being conveyed by the LCD is visible through the at least light transparent portion of the dial.

22. The electronic device as claimed in claim 21, wherein the light source is comprised of one or more LEDs.

23. The electronic device as claimed in claim 21, including switching means for actuation of the light source; wherein the LCD is not visible through the at least partially light transparent dial when the light source is not illuminated.

24. The electronic device as claimed in claim 21, wherein the selective activation of the portions of the area of the LCD go from dark to clear, and the light from the light source is bounded by dark portions of the LCD.

25. The electronic device as claimed in claim 21, wherein the selective activation of the portions of the area of the LCD go from clear to dark, and the light from the light source bounds the dark portions of the LCD.

26. The electronic device as claimed in claim 25, wherein the light source provides illumination of the dial outside of the area immediately above the LCD display, to facilitate reading of the information conveyed by the hands.
